(19) United States
(12) Patent Application Publication
(10) Pub. No.: US 2026/0286026 A1
(43) Pub. Date: Sep. 24, 2026

(54) METHOD OF MAKING WATER-SOLUBLE POLYMERS FOR USE AS SHALE ENCAPSULATORS FOR DRILLING FLUIDS

(71) Applicant: BASF SE, Ludwigshafen am Rhein (DE)

(72) Inventors: Oscar LAFUENTE CERDA, Trostberg (DE); Roland REICHENBACH-KLINKE, Trostberg (DE); Markus WOHLFAHRT, Trostberg (DE); Christian SCHOLZ, Trostberg (DE); Silke FLAKUS-TAUBE, Trostberg (DE)

(21) Appl. No.: 18/874,107

(22) PCT Filed: Jun. 12, 2023
(86) PCT No.: PCT/EP2023/065571

§ 371 Date: Dec. 12, 2024

(30) Foreign Application Priority Data
Jun. 14, 2022 (EP) 22178990.2

(51) Int. Cl. C08F 220/06; C09K 8/035

(52) U.S. Cl. CPC C08F 220/06; C09K 8/035; C08F 2800/10; C09K 2208/12

(57) ABSTRACT

A method for making water-soluble polymers in powder form, which comprise at least two different ethylenically unsaturated monomers, namely an ethylenically unsaturated monomer comprising at least one OH-group or an oxyalkylene group, and another monomer, by dosing the monomers over an aqueous solution comprising at least one radical initiator and drying the obtained polymer. And the use of these polymers in the field of oil drilling, in particular as shale encapsulators and/or shale inhibitors.

The present invention relates to a method for making water-soluble polymers in powder form, which comprise at least two different ethylenically unsaturated monomers, namely an ethylenically unsaturated monomer comprising at least one OH-group or an oxyalkylene group, and another monomer, by dosing the monomers over an aqueous solution comprising at least one radical initiator and drying the obtained polymer. The invention also relates to the use of these polymers in the field of oil drilling, in particular as shale encapsulators and/or shale inhibitors.

Incorporating hydroxyl functions in a water-soluble polymer, for example polymers comprising acrylic acid and/or arylamide, contributes interesting properties for certain industrial sectors. Examples include cation precipitation prevention agents, in particular in saline waters used in gas and oil extraction operations, surface agents on paper coatings or clay, and shale inhibitors or shale encapsulators in the oil drilling field.

In course of drilling wellbores, the cuttings generated by drilling are transported by the drilling fluid to the surface where they are separated from the drilling fluid and the drilling fluid thereafter is re-injected into the wellbore. The formations drilled through often comprise shale and clay. Clay and shale react with the water phase of a drilling fluid to promote stickiness, increase swelling, and induce sloughing. It is therefore known in the art to add shale and clay stabilizers to the drilling fluid. Such stabilizers adhere to the cuttings and the wellbore wall.

This encapsulation can effectively seal their surfaces and inhibits their reaction with the drilling fluid, minimizing sticking, swelling, and sloughing, and increasing borehole stability.

Unfortunately, incorporating hydroxyl functions poses many difficulties, particularly if one wishes to obtain high molecular weights. The hydroxyl functions may generate transfer phenomena and therefore ultimately create cross-linking problems. For example, the carboxyl function present in the acrylic acid may lead to unwanted esterification reactions. This esterification, whether it occurs during or after polymerization, causes the formation of an insoluble product that is therefore unsuitable for its use.

Polymers in powder or bead form are increasingly sought out and desired on an industrial level, since they are easy to transport and have a very high concentration of active material. Furthermore, they have a much longer lifetime relative to polymers in liquid or emulsion form, and have the advantage of not needing to contain additional protective agents such as biocides.

Document JP-1981-161413 describes a synthesis method by inverse suspension of nonlinear polymers containing hydroxyalkyl monomers. The cross-linking effect of the alcohol functions is exploited therein to thus obtain auto-cross-linking and therefore a water-swellable polymer.

US 2017/0204210 A1 discloses water-soluble polymers in bead or powder form which are obtained by inverse suspension or emulsion polymerization in the presence of a transfer agent.

They may be used as shale inhibitors in course of drilling. The polymers comprise at least two different ethylenically unsaturated monomers, namely an ethylenically unsaturated monomer comprising an OH-group, such as for example hydroxypropyl acrylate, and another monomer, in particular acrylic acid. The amount of the OH-containing monomer is limited to less than 20 mol %. At the end of the reaction, water is evaporated, and polymer beads can be separated from the organic phase. The document comprises a comparative example in which the synthesis was carried out by solution polymerization followed by drying the aqueous solution. A mixture of acrylic acid, hydroxypropyl acrylate, water and NaOH was added into a reactor, thereafter initiators and a transfer agent were added and the mixture polymerized. Due to crosslinking, the obtained polymer powder contained more than 2 wt. % of insoluble amounts.

However, the inverse suspension and inverse emulsion polymerization require working with organic solvents. It is desirable to avoid working with organic solvents. Moreover, surfactants and emulsion stabilizers are needed for this process. These compounds are costly and can have negative impacts on the final application of the product. In addition, the process described above involves many different steps. It starts with the generation of the emulsion, followed by the polymerization itself. Then the polymer beads need to be filtered off and dried from residual water and solvent. Finally, there is a distillation step to recycle the solvent. All these steps make the process lengthy, costly and also not very robust.

For these reasons, a radical polymerization in aqueous solution is highly desired. However, no successful method for such radical polymerization in aqueous solution is disclosed in the prior art. As shown in comparatives examples CE-1 and CE-2 of US 2017/0204210 A1 and the present comparative example No. 2, the polymerization cannot be carried out successfully by simply mixing the monomers and a radical initiator in a reaction vessel.

WO 2011/118728, CN 113 072 666, CN 111 072 666, JP H03 197519 A, US 2013/289171 and EP 0344589 disclose methods to prepare an aqueous solution of water-soluble polymers. However, the obtained water-soluble polymer is not dried to prepare the powder form. And none of these prior art documents disclose the use and the advantages of the water-soluble copolymers in powder form in the field of oil drilling, in particular as shale encapsulators and/or shale inhibitors.

It was therefore the objective of the present invention, to provide a method of making water-soluble copolymers in powder form comprising at least two different ethylenically unsaturated monomers, namely an ethylenically unsaturated monomer comprising an OH-group or an oxyalkylene group, and another monomer by radical polymerization in aqueous solution.

The Applicant has discovered that continuously dosing the monomers over time into an aqueous solution comprising at least one radical initiator and, afterwards drying the obtained polymer, made it possible to obtain a water-soluble polymer in powder form, with a high molecular weight.

Accordingly, the present invention relates to a method for preparing a water-soluble polymer in powder form by radically polymerizing at least two water-soluble, monoethylenically unsaturated monomers (A) and (B), wherein
monomer (A) is of the formula H₂C═C(R¹)—CO—X—R², wherein R¹ is H or CH₃, X is O or NR³, wherein R³ is H or CH₃, and R² is a hydrocarbon group comprising at least one OH pendant group or a group of the formula —(CH₂CH(R⁴)—O)ₙNR⁵, wherein R⁴ and R⁵ are, independently, H or CH₃, and n is chosen from 1 to 20, and wherein the amount of monomer (A) is 0.1 to 30 mol %, relating to the total of all monomers, and
monomer (B) is a monomer different from (A), having the general formula H₂C═C(R¹)—R⁶, wherein R¹ has the meaning as defined above, and R⁶ is a hydrophilic group, and wherein the amount of monomer (B) is 70 to 99.9 mol %, relating to the total of all monomers,
   characterized in that the method comprises, at least, the following steps
i) adding an aqueous base fluid into a vessel,
ii) adding at least one radical initiator into the vessel and dissolving the radical initiator(s) in the aqueous base fluid,
iii) continuously dosing the monomers into the vessel, and
iv) removing the obtained water-soluble polymer from the vessel and drying it,
   and wherein the maximum temperature of the vessel is equal or less than 100° C. at any point during the method.

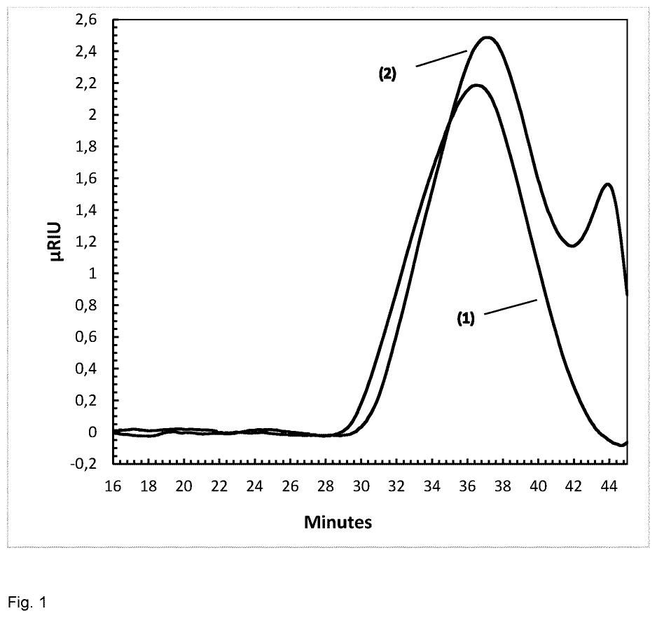

### LIST OF FIGURES

| | |
|---|---|
| FIG. 1: | Results of the GPC analysis of the comparative example 2. |

### Monomers to be Used

For the process of the present invention, at least two water-soluble, monoethylenically unsaturated monomers (A) and (B) are used, wherein
monomer (A) is of the formula H₂C═C(R¹)—CO—X—R², wherein R¹ is H or CH₃, X is O or NR³, wherein R³ is H or CH₃, and R² is a hydrocarbon group comprising at least one OH pendant group or a group of the formula —(CH₂CH(R⁴)—O)ₙR⁵, wherein R⁴ and R⁵ are, independently, H or CH₃, and n is chosen from 1 to 20, and wherein the amount of monomer (A) is 0.1 to 30 mol %, relating to the total of all monomers, and
monomer (B) is a monomer different from (A), having the general formula H₂C═C(R¹)—R⁶, wherein R¹ has the meaning as defined above, and R⁶ is a hydrophilic group, and wherein the amount of monomer (B) is 70 to 99.9 mol %, relating to the total of all monomers.

In one embodiment, the R² group is a C₁-C₁₂ hydrocarbon group comprising at least an OH pendant group, preferably a C₁-C₆ hydrocarbon group, and most preferably a C₁-C₄ hydrocarbon group.

In one embodiment, at least one monomer (A) is selected from hydroxyalkyl (meth)acrylates, hydroxyalkyl (meth)acrylamide and amino alcohol (meth)acrylates, wherein the term “alkyl” is a linear alkyl group comprising 1 to 12 carbon atoms, preferably 1 to 6 carbon atoms, most preferably 1 to 4 carbon atoms.

In a further embodiment, at least one monomer (A) is a hydroxyalkyl (meth)acrylate selected from hydroxymethyl (meth)acrylate, hydroxyethyl (meth)acrylate, hydroxypropyl (meth)acrylate, hydroxybutyl (meth)acrylate, for example 2,3-dihydroxypropyl methacrylate.

In another embodiment, at least one monomer (A) is a hydroxyalkyl (meth)acrylamide selected from hydroxymethyl (meth)acrylamide, hydroxyethyl (meth)acrylamide, hydroxypropyl (meth)acrylamide, and hydroxybutyl (meth)acrylamide.

In another embodiment, at least one monomer (A) is an amino alcohol (meth)acrylates, for example N-[tris(hydroxymethyl)aminomethane] (meth)acrylamide.

In one preferred embodiment, at least one monomer (A) is hydroxypropyl (meth)acrylate.

In one embodiment, the water-soluble polymer comprises 0.1 to 30 mol % of at least one monomer (A), preferably 5 to 25 mol %, most preferably 15 to 25 mol %, relating to the total of all monomers.

In one embodiment, at least one monomer (B) may be selected from:
an anionic monomer, preferably chosen from among acrylic acid, methacrylic acid, itaconic acid, maleic acid, 2-acrylamido-2-methylpropane sulfonic acid (ATBS), said monomers being in acid form, partially salified or totally salified;
a non-ionic monomer, preferably chosen from among acrylamide, methacrylamide, N,N′-dimethlacrylamide, N-vinyl pyrrolidone, N-vinyl formamide, methacrylates, diacetoneacrylamide and N-isopropylacrylamide.

In one embodiment, at least one of monomer (B) is a cationic monomer. In a preferred embodiment, the cationic monomer amounts to less than 10 mol %, relating to the total of all monomers. Suitable cationic monomers (B) are monomers comprising ammonium groups, in particular ammonium derivatives of N-(o-aminoalkyl) (meth)acrylamides or L-aminoalkyl (meth)acrylic esters.

In particular, the monomers (B) having ammonium groups may be compounds of the general formulae H₂C═C(R⁷)—CO—NR¹⁰—R⁸—NR⁹₃⁺ X⁻ (I) and/or H₂C═C(R⁷)—COO—R⁸—NR⁹₃⁺ X⁻ (II), where R⁷ is H or methyl, R⁸ is a preferably linear C₁-C₄-alkylene group and R¹⁰ is H or a C₁-C₄-alkyl group, preferably H or methyl. The radicals R⁹, independently of one another, are C₁-C₄-alkyl, preferably methyl, or a group of the general formula-R¹¹—SO₃H, where R¹¹ is a preferably linear C₁- to C₄-alkylene group or a phenylene group, with the proviso that generally not more than one of the substituents R⁹ is a substituent having sulfonic acid groups. The three substituents R⁹ are particularly preferably methyl groups, i.e. the monomer has a group —N(CH₃)₃⁺. X⁻ in the above formula is a monovalent anion, for example Cl⁻. X⁻ can of course also be a corresponding fraction of a polyvalent anion, although this is not preferred. Examples of suitable cationic monomers (B) of the general formula (I) or (II) comprise salts of 3-trimethylammonium propylacrylamides or 2-trimethylammonium ethyl (meth)acrylates, for example the corresponding chlorides, such as 3-trimethylammonium propylacrylamide chloride (DIMAPAQUAT) and 2-trimethylammonium ethyl methacrylate chloride (MADAME-QUAT).

In one embodiment of the invention, monomer (B) is (meth)acrylic acid or a salt thereof.

In one embodiment, the water-soluble polymer comprises 70 to 99.9 mol % of at least one monomer (B), preferably 75 to 95 mol %, most preferably 75 to 85 mol %, relating to the total of all monomers.

In one preferred embodiment, the water-soluble polymer comprises 75-85 mol % of (meth)acrylic acid or a salt thereof and 15-25 mol % of monomer (A) as previously defined.

In one embodiment of the invention, the water-soluble polymer may also comprise further monomers, besides monomers (A) and (B).

In another embodiment of the invention, the water-soluble polymer only contains monomers (A) and (B).

### Water-Soluble Polymer Prepared

The water-soluble polymer prepared via the process of the present invention, comprises the monomers indicated above in the amounts as also indicated above including preferred embodiments.

The weight average molecular weight (M_{w}) of the water-soluble polymer is selected by the skilled artisan according to its intended use. For many applications high molecular weights are desirable. In one embodiment, the molecular weight (M_{w}) of the water-soluble polymer is in the range of 500,000 to 1,500,000 g/mol, preferably 600,000 to 1,200,000 g/mol.

And the water-soluble polymer obtained comprises less than 2 wt. % of insoluble amounts.

The molecular weight, the viscosity and the insoluble amounts of the polymer prepared are analyzed as will be described below.

### Method to be Used

The present invention relates to a method for preparing a water-soluble polymer in powder form by radically polymerizing at least two water-soluble, monoethylenically unsaturated monomers (A) and (B), wherein
monomer (A) is of the formula H₂C═C(R¹)—CO—X—R², wherein R¹ is H or CH₃, X is O or NR³, wherein R³ is H or CH₃, and R² is a hydrocarbon group comprising at least one OH pendant group or a group of the formula —(CH₂CH(R⁴)—O)ₙR⁵, wherein R⁴ and R⁵ are, independently, H or CH₃, and n is chosen from 1 to 20, and wherein the amount of monomer (A) is 0.1 to 30 mol %, relating to the total of all monomers, and
monomer (B) is a monomer different from (A), having the general formula H₂C═C(R¹)—R⁶, wherein R¹ has the meaning as defined above, and R⁶ is a hydrophilic group, and wherein the amount of monomer (B) is 70 to 99.9 mol %, relating to the total of all monomers, characterized in that the method comprises, at least, the following steps
i) adding an aqueous base fluid into a vessel,
ii) adding at least one radical initiator into the vessel and dissolving the radical initiator(s) in the aqueous base fluid,
iii) continuously dosing the monomers into the vessel, and
iv) removing the obtained water-soluble polymer from the vessel and drying it,
   and wherein the maximum temperature of the vessel is equal or less than 100° C. at any point during the method.

As described above, the method for preparing the water-soluble polymer in powder form comprises at least steps i) to iv).

In course of step i), an aqueous base fluid is added into the reaction vessel. In one embodiment, the vessel is then heated before proceeding to step ii). In a further embodiment, the vessel is heated to a temperature between 45 to 85° C., preferably between 55 and 85° C., more preferably between 55 and 70° C.

The term “aqueous base fluid”, as used throughout this invention, is intended to cover any solution comprising water. The aqueous base fluid may additionally comprise an organic solvent miscible with water. In one embodiment, the aqueous base fluid comprises at least 50 wt. % of water, preferably at least 80 wt. %, most preferably at least 95 wt. %, relating to the total of all components of the aqueous base fluid. In a further embodiment of the present invention, the aqueous base fluid is only water.

In course of step ii), at least one radical initiator is added into the reaction vessel and the radical initiator(s) is dissolved in the aqueous base fluid. In one embodiment, the radical initiator(s) has a 10 h t½ temperature in water of 20 to 70° C., preferably 40 to 60° C. In a further embodiment, the radical initiator(s) is selected from 2,2′-[Azobis(1-methylethyliden)]bis[4,5-dihydro-1H-imidazoldihydrochlorid (Wako VA-044, which has a 10 h t1/2 temperature in water of 44° C.); 2,2′-Azobis[2-methylpropionamidin]dihydrochloride (WakoV50, which has a 10 h t1/2 temperature in water 56° C.) and sodium peroxodisulphate. In one preferred embodiment, the radical initiator is 2,2′-[Azobis(1-methylethyliden)]bis[4,5-dihydro-1H-imidazoldihydrochlorid (Wako VA-044).

In course of step iii), the monomers are continuously dosed into the reaction vessel. In one embodiment, the monomers in step iii) are dosed into the vessel via a dropping funnel, via a pump, such as a peristaltic pump, or via any other dosing means known to the skilled person.

In one embodiment, the monomers are continuously dosed into the reaction vessel over the course of 15 to 120 min, preferably 30 to 90 min, and more preferably 45 to 75 min. In one embodiment, the dosage rate of the monomers may be controlled to not exceed the desired upper limit of the vessel temperature.

In one embodiment, the monomers are dosed into the reaction vessel as a monomer mixture. Alternatively, in another embodiment, the monomers are dosed into the reaction vessel separately. When the monomers are added separately, they may be dosed at the same dosing rate or at different dosing rates.

In another embodiment, up to 30 wt. % of the monomers used in the method, relating to the total amount of monomers added into the vessel during the method, are added into the reaction vessel before the radical initiator(s).

In one embodiment, the vessel is cooled after the start of the reaction between the monomers and the radical initiator(s), in order to control the desired upper limit of the vessel temperature. In one embodiment, the cooling is carried out by using a cooling jacket or a recirculating cooler or adding cold water into the vessel, or any other cooling means known to the skilled person.

In one embodiment, when at least one of the monomers is a salt of (meth)acrylic acid, the salt may be pre-prepared and then added to the reaction vessel. Alternatively, the reactants may be added to the reaction vessel separately. In a preferred embodiment, when at least one of the monomers is sodium acrylate, the sodium acrylate may be pre-prepared and then added to the reaction vessel. Or alternatively, acrylic acid and NaOH may be added separately into the vessel.

In one embodiment, the reaction vessel is stirred for 30 min to 3 h at a temperature between 45 to 85° C. after competition of the monomers dosage, preferably between 55 and 85° C., more preferably between 55 and 70° C.

In one embodiment, an additional amount of radical initiator(s) is added into the vessel after completion of the monomers dosage.

In one embodiment, the final polymer concentration in the reaction vessel, before step iv), is in the range from 18 to 35 wt. %, preferably from 18 to 30 wt. %

In one embodiment, the temperature of the vessel is maintained equal or less than 100° C. by means of cooling, such as using a cooling jacket or a recirculating cooler or adding cold water into the vessel. And in one preferred embodiment, the maximum temperature of the vessel is equal or less than 90° C. at any point during the method, preferably equal or less than 85° C.

In course of step iv), the obtained water-soluble polymer is removed from the vessel and it is dried. In one embodiment, the polymer is dried using a drum dryer. In a further embodiment, the polymer is dried by means of a drum dryer for 30 s to 5 min at a temperature of 110 to 180° C.

An additional advantage of the process of this invention over the prior art, e. g. the process exemplified in EP 3 177 654 B1, is that no transfer agent is necessary.

### Further Embodiments

Furthermore, in another embodiment, the invention also relates to the use of water-soluble polymers, as described by a process as described above, in the field of oil drilling. In one preferred embodiment, the invention related to the use of the water-soluble polymers as shale encapsulators and/or shale inhibitors in oil drilling operations.

For oil drilling operations, the powder comprising the water-soluble polymers may be dissolved in an aqueous fluid to prepare the wellbore treatment fluid. The aqueous base fluid may comprise freshwater or a brine, optionally selected from seawater, saturated NaCl, and KCl. Preferably, the aqueous base fluid is not a calcium brine having a calcium content above 500 mg/L. The dilution rates may vary and should be based on the depletion rate of the shale encapsulator or the shale inhibitor.

The concentration of water-soluble polymers in the wellbore treatment fluid used in oil drilling operations may range between 1.4 and 11.4 kg/m³.

Furthermore, the powder comprising the water-soluble polymers may be pre-dissolved to a concentration of 11.4 to 14.2 kg/m³, before the final dilution into the wellbore treatment fluid.

In a preferred embodiment, the pH of the wellbore treatment fluid comprising the water-soluble polymers is kept below 10.

In another embodiment, the invention related to the use of water-soluble polymers, as described by a process as described above, in the fields of gas recovery (or extraction), oil recovery (or extraction), paper manufacturing, water treatment, or agriculture.

The invention is further illustrated by the following examples, which were analyzed as herein indicated:

### Analysis of the Polymers

### Gel Permeation Chromatography

The molecular weight distribution of the polymer samples was analyzed by gel permeation chromatography. A combination of three different columns was used (Shodex OHpak SB-G, Shodex SB-807HQ and Shodex SB-806HQ). The eluent was a mixture of 0.05 M ammonium formiate/methanol (80:20 Vol %) at a flow rate of 0.5 ml/min. Detection was performed by refractive index.

### Analysis of Residual Monomer Contents

The amount of unpolymerized monomers was analyzed by HPLC. A Nucleosil C18 column by Machery Nagel was used. A mixture of methanol and 0.05 M aqueous KH₂PO₄ solution with pH of 3.5 was used as eluent.

### Viscosity Measurements

For the viscosity measurements an aqueous solution comprising 5 wt. % of the polymer was prepared and the viscosity was determined by means of a Brookfield HV viscometer at 25° C. and rotating speed of 20 rpm with spindle No. 1.

### Amount of Insolubles

The content of insolubles in the polymer powders was measured according to the following procedure:
1. 1 g of polymer powder was poured into 200 ml tap water and stirred for 2 h.
2. The polymer solution was filtered through a 200 μm stainless steel screen.
3. After the filter was drained, it was rinsed with water.
4. If less than 30 spots remain on the filter the insoluble content is rated as <1 wt. %. If the screen is covered but the solution was filtered through the insoluble content is reported as <2 wt. %. If the solution does not filter through the screen, the screen is dried and weighed. The insoluble content is calculated from the difference of the initial weight of the filter screen and the one after filtration and drying.

### EXAMPLES

### Comparative Example 1: Bead Polymerization

Copolymer of sodium acrylate (79.5 mol %) and hydroxypropyl acrylate (20.5 mol %) by bead polymerization.

For comparative purposes, a commercially available copolymer made by the bead polymerization process was used.

The product has a viscosity of 140 mPas (measured in 5 wt. % aqueous solution by Brookfield HV viscometer at 25° C. and rotating speed of 20 rpm with spindle 1). Residual acrylic acid was determined by HPLC as 0.11 wt. % and residual HPA as 0.01 wt. %. The molecular weight (M_{w}) was measured by GPC as 823,000 Da. The insoluble content was determined as <1 wt. %.

### Comparative Example 2: Solution Polymerization

Copolymer of sodium acrylate (79.5 mol %) and hydroxypropyl acrylate (20.5 mol %) by solution polymerization.

640 g tap water were charged into a 2 L round bottom flask, which was equipped with a condenser, pH electrode, stainless steel stirrer and thermometer. Next, 89.6 g acrylic acid were added and then carefully neutralized under cooling with 193 g 20 wt. % NaOH solution. The temperature was maintained below 25° C. during the neutralization. Finally, 41.6 g hydroxypropyl acrylate (HPA) were added. Then the monomer solution was purged with nitrogen and heated to the starting temperature of 45° C. Once the starting temperature was reached 2.6 g of the azo initiator 2,2′-Azobis[2-methylpropionamidin]dihydrochlorid (Wako V50; 8 wt. % aqueous solution), 4 g sodium peroxodisulfate (20 wt. % aqueous solution) and 0.65 g sodium sulfite (20 wt. % aqueous solution) were added to initiate the polymerization. Immediately, an exothermic reaction was observed and within approx. 30 min the temperature rose to 61° C.

At this point a sample was taken and analyzed for unreacted monomers by HPLC and the molecular weight of the polymers obtained was analyzed by gel permeation chromatography (GPC). This sample contained still a high amount of unpolymerized acrylic acid (3.66 wt. %), while the share of unpolymerized HPA was already quite low (0.14 wt. %). These findings indicate that the reactivity of the HPA is higher than the one of acrylic acid. Initially the amount of acrylic acid in the monomer solution was 9.3 wt. % and HPA 4.3 wt. %, i.e. the initial ratio of acrylic acid/HPA of roughly 2:1 changed to 26:1 during the first 30 min of the polymerization reaction.

After the exothermic reaction came to an end, the temperature was increased to 75° C. and maintained at this temperature for 2 h. At the end of the reaction the polymer solution was again analyzed for unreacted monomers by HPLC and molecular weight by gel permeation chromatography. A residual amount of 0.52 wt. % acrylic acid and 0 wt. % HPA was found. The final polymer solution had an active content of 13.5 wt. % and a viscosity of 24 000 mPas at 20° C.

The result of the GPC analysis is shown in FIG. 1. It reveals a single peak for the first sample (line (1) in FIG. 1). However, during the further polymerization at 75° C. a second peak of lower molecular weight evolved (line (2) in FIG. 1). Considering the results from the monomer analytics, it can be concluded that this second peak can be assigned to a homopolymer of poly(acrylic acid), i.e. the final product consists of a mixture of poly(acrylic acid) and HPA-acrylic acid copolymer.

The solution was dried with a lab drum dryer (type Merto Drum L, producer Deutsche Vakuum Apparate, Holland Merten GmbH) at a temperature of 170° C. and rotation speed of 1 rpm.

The resulting powder had a viscosity of 4050 mPas (measured in 5 wt. % aqueous solution by Brookfield HV viscometer at 25° C. and rotating speed of 20 rpm with spindle 1). The molecular weight (M_{w}) was measured by GPC as 1,900,000 Da. For this polymer an insoluble content of <2 wt. % was measured.

In conclusion, it is shown that due to the different reactivity of the monomers acrylic acid and HPA homogeneous copolymers cannot be obtained by the above process of solution polymerization.

### Inventive Example 1

Copolymer of sodium acrylate (79.5 mol %) and hydroxypropyl acrylate (20.5 mol %) made by the process according to the present invention.

### Preparation of a Sodium Acrylate Solution (39.6 wt. % Sodium Acrylate):

760 g 20% aq. NaOH were placed in a 2 L reaction vessel with cooling jacket. A dropping funnel containing 360 g acrylic acid was attached to the vessel and the acid was dropped carefully into the NaOH-solution within 120 min. The temperature was held below 25° C. The final pH was measured as 5.7.

### Polymer Synthesis:

500 g water were placed in a 2 L reaction vessel fitted with a dropping funnel, stainless steel stirrer, pH control and thermometer. Under nitrogen purging and stirring the liquid was heated to 55° C. At this temperature 0.21 g of Wako V50 and 0.8 g sodium peroxodisulfate were added and dissolved for 5 min.

Next, a mixture of 275 g of the sodium acrylate solution prepared as above and 41.6 g HPA were added via the dropping funnel within 35 min. A temperature increase of a maximum of 63° C. was observed. The reaction mixture was stirred at 60° C. for further 2 h.

The final polymer solution had a viscosity of 31 000 mPas (20° C., Brookfield HV 20 rpm) and a solid content of 18.4 wt. %. pH was measured as 5.7.

The solution was dried with a lab drum dryer (type Merto Drum L, producer Deutsche Vakuum Apparate, Holland Merten GmbH) at a temperature of 170° C. and rotation speed of 1 rpm.

The resulting powder had a viscosity of 820 mPas (5 wt. % aqueous solution). Residual acrylic acid was determined by HPLC as 0.38 wt. % and residual HPA as 0 wt. %. The molecular weight (M_{w}) was measured by GPC as 1,191,000 Da. The insoluble content was determined as <2 wt. %.

### Inventive Example 2

Copolymer of sodium acrylate (79.5 mol %) and hydroxypropyl acrylate (20.5 mol %) made by the process according to the present invention.

In the following example, the monomers were added slower.

500 g water were placed in a 2 L reaction vessel fitted with a dropping funnel, stainless steel stirrer, pH control and thermometer. Under nitrogen purging and stirring the liquid was heated to 57° C. At this temperature 0.21 g of the azo initiator 2,2′-Azobis[2-methylpropionamidin]dihydrochloride (Wako V50) and 0.8 g sodium peroxodisulfate were added and dissolved for 5 min.

Next, a mixture of 275 g of the sodium acrylate solution prepared as described in example 1 and 41.6 g HPA were added via the dropping funnel within 60 min. A temperature increase to a maximum of 62° C. was observed. The reaction mixture was stirred at 60° C. for further 2 h.

The final polymer solution had a viscosity of 15 000 mPas (20° C.) and a solid content of 18.2 wt. %. pH was measured as 5.7.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 230 mPas. Residual acrylic acid was determined by HPLC as 0.32 wt. % and residual HPA as 0 wt. %. The molecular weight (M_{w}) was measured by GPC as 834,000 Da. The insoluble content was determined as <2 wt. %.

### Inventive Example 3

Copolymer of sodium acrylate (79.5 mol %) and hydroxypropyl acrylate (20.5 mol %) made by the process according to the present invention.

### Preparation of Monomer Solution (39.1 wt. %):

570 g 20 wt. % aq. NaOH were placed in a 4 L reaction vessel with cooling jacket. A dropping funnel containing 270 g acrylic acid was attached to the vessel and the acid was dropped carefully into the NaOH-solution within 120 min. The temperature was held below 25° C. Finally, 126 g HPA were added and the monomer solution was purged with nitrogen.

### Polymer Synthesis:

780 g water were placed in a 4 L reaction vessel fitted with a dropping funnel, stainless steel stirrer, pH control and thermometer. Under nitrogen purging and stirring the liquid was heated to 53° C. At this temperature 0.6 g of the azo initiator 2,2′-Azobis[2-methylpropionamidin]dihydrochloride (Wako V50) and 2.5 g sodium peroxodisulfate were added and dissolved for 5 min.

Next, the monomer solution as described above was added via the dropping funnel within 90 min, maintaining a temperature rise to maximum 65° C. The reaction mixture was stirrer at 60° C. for further 60 min.

The final polymer solution had a viscosity of 9 000 mPas (50° C.) and a solid content of 22.8 wt. %. pH was measured as 6.1.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 300 mPas. Residual acrylic acid was determined by HPLC as 0.12 wt. % and residual HPA as 0.01 wt. %. The molecular weight (M_{w}) was measured by GPC as 701,000 Da. The insoluble content was determined as <2 wt. %.

### Inventive Example 4

Copolymer of sodium acrylate (85 mol %) and hydroxypropyl acrylate (15 mol %) made by the process according to the present invention.

### Preparation of Monomer Solution:

660 g tap water and 230 g 50 wt. % aq. NaOH were placed in a 2 L reaction vessel with cooling jacket. A dropping funnel containing 270 g acrylic acid was attached to the vessel and the acid was dropped carefully into the NaOH-solution within 120 min. The temperature was held below 25° C. Finally, 94.5 g HPA were added and the monomer solution was purged with nitrogen.

### Polymer Synthesis:

500 g water were placed in a 2 L reaction vessel fitted with a dropping funnel, stainless steel stirrer, pH control and thermometer. Under nitrogen purging and stirring the liquid was heated to 55° C. At this temperature 0.6 g of the azo initiator 2,2′-Azobis[2-methylpropionamidin]dihydrochloride (Wako V50) dissolved in 5 g water and 2.5 g sodium peroxodisulfate dissolved in 5 g water were added. Next, the monomer solution was added via the dropping funnel within 90 min, maintaining a temperature rise to maximum 65° C. The reaction mixture was stirrer at 60° C. for further 60 min.

The final polymer solution had a viscosity of 114 000 mPas (20° C.) and a solid content of 23.0 wt. %. pH was measured as 4.9.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 600 mPas.

Residual acrylic acid was determined by HPLC as 0.12 wt. % and residual HPA as 0.01 wt. %. The molecular weight (M_{w}) was measured by GPC as 1,116,000 Da. The insoluble content was determined as <1 wt. %.

### Inventive Example 5

Copolymer of sodium acrylate (75 mol %) and hydroxypropyl acrylate (25 mol %) made by the process according to the present invention.

### Preparation of Monomer Solution:

660 g tap water and 230 g 50 wt. % aq. NaOH were placed in a 2 L reaction vessel with cooling jacket. A dropping funnel containing 270 g acrylic acid was attached to the vessel and the acid was dropped carefully into the NaOH-solution within 120 min. The temperature was held below 25° C. Finally, 157.5 g HPA were added and the monomer solution was purged with nitrogen.

### Polymer Synthesis:

500 g water were placed in a 2 L reaction vessel fitted with a dropping funnel, stainless steel stirrer, pH control and thermometer. Under nitrogen purging and stirring the liquid was heated to 55° C. At this temperature 0.6 g Wako V50 dissolved in 5 g water and 2.5 g sodium peroxodisulfate dissolved in 5 g water were added. Next, the monomer solution was added via the dropping funnel within 90 min, maintaining a temperature rise to maximum 65° C. The reaction mixture was stirrer at 60° C. for further 60 min.

The final polymer solution had a viscosity of 152 000 mPas (20° C.) and a solid content of 24.1 wt. %. pH was measured as 4.9.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 600 mPas. Residual acrylic acid was determined by HPLC as 0.1 wt. % and residual HPA as 0.01 wt. %. The molecular weight (M_{w}) was measured by GPC as 1,097,000 Da. The insoluble content was determined as <2 wt. %.

### Inventive Example 6

Copolymer of sodium acrylate (79.5 mol %) and hydroxypropyl acrylate (20.5 mol %) made by the process according to the present invention.

The synthesis route was modified in this example. Instead of preparing a combined monomer solution, acrylic acid, HPA, and a NaOH solution were charged separately into the reactor. A minor amount of sodium acrylate and HPA was already initially present in the reactor (30 wt. % relating to the total of monomers). 4400 g water were placed in a 10 L reaction vessel fitted with a cooling jacket, stainless steel stirrer, pH control and thermometer. The stirrer was started and 340 g 50 wt. % aq. NaOH, 324 g acrylic acid and 152 g HPA were charged into the reactor. Under nitrogen purging and further stirring the liquid was heated to 54° C. At this temperature 2.4 g of the azo initiator 2,2′-Azobis[2-methylpropionamidin]dihydrochloride (Wako V50) dissolved in 50 g water and 10 g sodium peroxodisulphate dissolved in 50 g water were added. An exothermic reaction was observed and the cooling was activated. To support the cooling 400 g of cold water was added as well.

Next, the addition of 756 g acrylic acid and 353 g HPA was started. Both monomers were dosed via peristaltic pumps at a rate of 750 g/h resp. 450 g/h. When a temperature of 67° C. and a pH of 4.5 was reached, the addition of 800 g 30 wt. % NaOH at a flow rate of 750 g/h was initiated to keep the pH at around 4.5. To keep the temperature maximum below 70° C. further portions of altogether 700 g cold water were added during the polymerization. The dosage of the monomers was finished after 70 min.

The final polymer solution had a viscosity of 30 000 mPas (20° C.) and a solid content of 22 wt. %. pH was measured as 4.5.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 300 mPas. Residual acrylic acid was determined by HPLC as 0.08 wt. % and residual HPA as 0 wt. %. The molecular weight (M_{w}) was measured by GPC as 944,000 Da. The insoluble content was determined as <2 wt. %.

### Comparative Example 3

Copolymer of sodium acrylate (79.5 mol %) and hydroxypropyl acrylate (20.5 mol %).

For comparative purposes, the product was not dried but the copolymer as such used for the tests.

1000 g water were placed in a 2 L reaction vessel fitted with a cooling jacket, stainless steel stirrer, pH control and thermometer. The stirrer was started and under nitrogen purging the liquid was heated to 58° C. At this temperature 0.6 g of the azo initiator 2,2′-Azobis[2-methylpropionamidin]dihydrochloride (Wako V50) dissolved in 10 g water and 2.5 g sodium peroxodisulphate dissolved in 10 g water were added. Immediately, the addition of 270 g acrylic acid, 126.2 g HPA and 460 g 25 wt. % NaOH was started. All components were dosed via peristaltic pumps at rates of 185 g/h, 100 g/h resp. 350-400 g/h. The addition of NaOH was adjusted to keep the pH between 5-5.5. The dosage of the monomers was finished after 80 min.

The final polymer solution had a viscosity of 124 000 mPas (20° C.) and a solid content of 24.4 wt. %. pH was measured as 5.5. The viscosity of a 5 wt. % aqueous solution was measured as 320 mPas. Residual acrylic acid was determined by HPLC as 0.13 wt. % and residual HPA as 0 wt. %. The molecular weight (M_{w}) was measured by GPC as 1,200,000 Da.

### Inventive Example 7

Copolymer of sodium acrylate (79.5 mol %) and hydroxypropyl acrylate (20.5 mol %) made by the process according to the present invention.

4200 g water were placed in a 10 L reaction vessel fitted with a cooling jacket, stainless steel stirrer, pH control and thermometer. The stirrer was started and 105 g 50 wt. % aq. NaOH, 108 g acrylic acid and 50 g HPA were charged into the reactor.

Under nitrogen purging and further stirring the liquid was heated to 56° C. At this temperature 2.4 g of the azo initiator 2,2′-Azobis[2-methylpropionamidin]dihydrochloride (Wako V50) dissolved in 50 g water and 10 g sodium peroxodisulphate dissolved in 50 g water were added. An exothermic reaction was observed and the cooling was activated. Next, the addition of 970 g acrylic acid, 445 g HPA and 1380 g 30 wt. % NaOH was started. These components were dosed via peristaltic pumps at a rate of 800 g/h, 600 g/h resp. 1200 g/h. The addition of NaOH was adjusted to keep the pH between 5-5.5. During the polymerization a maximum temperature of 73° C. was reached. The dosage of the monomers was finished after 70 min.

The final polymer solution had a viscosity of 10 000 mPas (20° C.) and a solid content of 25 wt. %. pH was measured as 5.2.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 90 mPas. Residual acrylic acid was determined by HPLC as 0.08 wt. % and residual HPA as 0.007 wt. %. The molecular weight (M_{w}) was measured by GPC as 663,000 Da. The insoluble content was determined as <1 wt. %.

### Inventive Example 8

Copolymer of sodium acrylate (79.5 mol %) and hydroxypropyl acrylate (20.5 mol %) made by the process according to the present invention.

3300 g water were placed in a 10 L reaction vessel fitted with a cooling jacket, stainless steel stirrer, pH control and thermometer. The stirrer was started and 258 g 50 wt. % aq. NaOH, 233 g acrylic acid and 109 g HPA were charged into the reactor. Under nitrogen purging and further stirring the liquid was heated to 55° C. At this temperature 1.7 g Wako V50 dissolved in 20 g water and 7.2 g sodium peroxodisulphate dissolved in 20 g water were added. An exothermic reaction was observed and the cooling was activated. Next, the addition of 544 g acrylic acid, 254 g HPA and 400 g 50 wt. % NaOH was started. These components were dosed via peristaltic pumps at a rate of 550 g/h, 250 g/h resp. 550 g/h. The addition of NaOH was adjusted to keep the pH between 4.5-5.0. During the polymerization a maximum temperature of 69° C. was reached. The dosage of the monomers was finished after 60 min.

The final polymer solution had a viscosity of 80 000 mPas (20° C.) and a solid content of 25 wt. %. pH was measured as 4.6.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 350 mPas. Residual acrylic acid was determined by HPLC as 0.12 wt. % and residual HPA as 0 wt. %. The molecular weight (M_{w}) was measured by GPC as 1,141,000 Da. The insoluble content was determined as <1 wt. %.

### Inventive Example 9

Copolymer of sodium acrylate (79.5 mol %) and hydroxypropyl acrylate (20.5 mol %) made by the process according to the present invention.

In this example, a different initiator package was used. 2,2′-[Azobis(1-methylethyliden)]bis[4,5-dihydro-1H-imidazoldihydrochlorid (10 h t1/2 temperature in water 44° C.; Wako VA-044) was used instead of 2,2′-Azobis[2-methylpropionamidin]dihydrochloride (10 h t1/2 temperature in water 56° C., WakoV50)+sodium peroxodisulphate.

1700 g water were placed in a 4 L reaction vessel fitted with a cooling jacket, stainless steel stirrer, pH control and thermometer. The stirrer was started and 128 g 50 wt. % aq. NaOH, 116 g acrylic acid and 55 g HPA were charged into the reactor. Under nitrogen purging and further stirring the liquid was heated to 57° C.

At this temperature 3 g of the azo initiator 2,2′-Azobis[2-methylpropionamidin]dihydrochloride (Wako® V50) dissolved in 15 g water were added. An exothermic reaction was observed and the cooling was activated. Next, the addition of 272 g acrylic acid and 127 g HPA was started. These components were dosed via peristaltic pumps at a rate of 230 g/h resp. 120 g/h. During the polymerization a maximum temperature of 72.5° C. was reached. The dosage of the monomers was finished after 60 min.

The final polymer solution had a viscosity of 100 000 mPas (20° C.) and a solid content of 24.5 wt. %. pH was measured as 4.2. The viscosity of a 5 wt. % aqueous solution was measured as 180 mPas. Residual acrylic acid was determined by HPLC as 0.21 wt. % and residual HPA as 0 wt. %. The molecular weight (M_{w}) was measured by GPC as 1,000,000 Da.

### Inventive Example 10

Copolymer of sodium acrylate (79.5 mol %) and hydroxypropyl acrylate (20.5 mol %) made by the process according to the present invention.

4400 g water were placed in a 10 L reaction vessel fitted with a cooling jacket, stainless steel stirrer, pH control and thermometer. The stirrer was started and 320 g 50 wt. % aq. NaOH, 290 g acrylic acid and 137.5 g HPA were charged into the reactor. Under nitrogen purging and further stirring the liquid was heated to 49° C.

At this temperature 3 g Wako VA-044 dissolved in 50 g water was added. An exothermic reaction was observed and the cooling was activated. Next, the addition of 680 g acrylic acid and 318 g HPA was started. These components were dosed via peristaltic pumps at a rate of 700 g/h resp. 300 g/h. During the polymerization a maximum temperature of 77° C. was reached. The dosage of the monomers was finished after 64 min. The pH was adjusted with 200 g 25 wt. % aq. NaOH to 6.3.

The final polymer solution had a viscosity of 82 000 mPas (20° C.) and a solid content of 23.3 wt. %.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 990 mPas. Residual acrylic acid was determined by HPLC as 0.08 wt. % and residual HPA as 0 wt. %. The molecular weight (M_{w}) was measured by GPC as 1,218,000 Da. The insoluble content was determined as <1 wt. %.

### Inventive Example 11

Copolymer of sodium acrylate (79.5 mol %) and hydroxypropyl acrylate (20.5 mol %) made by the process according to the present invention.

1600 g water were placed in a 4 L reaction vessel fitted with a cooling jacket, stainless steel stirrer, pH control and thermometer. The stirrer was started and 107 g 50 wt. % aq. NaOH, 97 g acrylic acid and 46 g HPA were charged into the reactor. Under nitrogen purging and further stirring the liquid was heated to 49° C.

At this temperature 2 g Wako VA-044 dissolved in 20 g water were added. An exothermic reaction was observed and the cooling was activated. Next, the addition of 227 g acrylic acid, 106 g HPA and 100 g 50 wt. % NaOH was started. These components were dosed via peristaltic pumps at a rate of 230 g/h, 100 g/h resp. 100 g/h. The addition of NaOH was adjusted to keep the pH between 5.0-5.5. During the polymerization a maximum temperature of 62.5° C. was reached. The dosage of the monomers was finished after 70 min.

The final polymer solution had a viscosity of 39 000 mPas (20° C.) and a solid content of 22.6 wt. %. pH was measured as 4.9.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 1500 mPas. Residual acrylic acid was determined by HPLC as 0.08 wt. % and residual HPA as 0 wt. %. The molecular weight (M_{w}) was measured by GPC as 1,176,000 Da.

### Inventive Example 12

Copolymer of sodium acrylate (79.5 mol %) and hydroxypropyl acrylate (20.5 mol %) made by the process according to the present invention.

1600 g water were placed in a 4 L reaction vessel fitted with a cooling jacket, stainless steel stirrer, pH control and thermometer. The stirrer was started and 107 g 50 wt. % aq. NaOH, 97 g acrylic acid and 46 g HPA were charged into the reactor. Under nitrogen purging and further stirring the liquid was heated to 49° C. At this temperature 2 g Wako VA-044 dissolved in 20 g water were added. An exothermic reaction was observed and the cooling was activated. Next, the addition of 227 g acrylic acid, 106 g HPA and 150 g 50 wt. % NaOH was started. These components were dosed via peristaltic pumps at a rate of 230 g/h, 100 g/h resp. 100 g/h. The addition of NaOH was adjusted to keep the pH between 5.0-5.5. During the polymerization a maximum temperature of 66° C. was reached. The dosage of the monomers was finished after 70 min.

The final polymer solution had a viscosity of 44 000 mPas (20° C.) and a solid content of 23.1 wt. %. pH was measured as 5.3.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 400 mPas. Residual acrylic acid was determined by HPLC as 0.07 wt. % and residual HPA as 0 wt. %. The molecular weight (M_{w}) was measured by GPC as 1,049,000 Da.

### Inventive Example 13

Copolymer of sodium acrylate (79.5 mol %) and hydroxypropyl acrylate (20.5 mol %) made by the process according to the present invention.

1600 g water were placed in a 4 L reaction vessel fitted with a cooling jacket, stainless steel stirrer, pH control and thermometer. The stirrer was started and 107 g 50 wt. % aq. NaOH, 97 g acrylic acid and 46 g HPA were charged into the reactor. Under nitrogen purging and further stirring the liquid was heated to 49° C. At this temperature 2 g Wako VA-044 dissolved in 20 g water were added. An exothermic reaction was observed and the cooling was activated. Next, the addition of 227 g acrylic acid, 106 g HPA and 200 g 50 wt. % NaOH was started. These components were dosed via peristaltic pumps at a rate of 230 g/h, 100 g/h resp. 100 g/h. The addition of NaOH was adjusted to keep the pH between 5.0-5.5. During the polymerization a maximum temperature of 66° C. was reached. The dosage of the monomers was finished after 70 min.

The final polymer solution had a viscosity of 24 000 mPas (20° C.) and a solid content of 23.0 wt. %. pH was measured as 5.7.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 300 mPas. Residual acrylic acid was determined by HPLC as 0.1 wt. % and residual HPA as 0 wt. %. The molecular weight (M_{w}) was measured by GPC as 950,000 Da.

### Inventive Example 14

Copolymer of sodium acrylate (79.5 mol %) and hydroxypropyl acrylate (20.5 mol %) made by the process according to the present invention.

4200 g water were placed in a 10 L reaction vessel fitted with a cooling jacket, stainless steel stirrer, pH control and thermometer. The stirrer was started and 320 g 50 wt. % aq. NaOH, 290 g acrylic acid and 137.5 g HPA were charged into the reactor. Under nitrogen purging and further stirring the liquid was heated to 49° C. At this temperature 3.6 g Wako VA-044 dissolved in 50 g water were added. An exothermic reaction was observed and the cooling was activated. Next, the addition of 680 g acrylic acid, 318 g HPA and 450 g 50 wt. % NaOH was started. These components were dosed via peristaltic pumps at a rate of 700 g/h, 300 g/h resp. 450 g/h. The addition of NaOH was adjusted to keep the pH between 4.5-5.5. During the polymerization a maximum temperature of 82° C. was reached. The dosage of the monomers was finished after 64 min.

The final polymer solution had a viscosity of 16 800 mPas (20° C.) and a solid content of 25 wt. %. pH was measured as 6.1.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 260 mPas. Residual acrylic acid was determined by HPLC as 0.34 wt. % and residual HPA as 0 wt. %. The molecular weight (M_{w}) was measured by GPC as 878,000 Da. The insoluble content was determined as <1 wt. %.

### Inventive Example 15

Copolymer of sodium acrylate (79.5 mol %) and hydroxypropyl acrylate (20.5 mol %) made by the process according to the present invention.

4200 g water were placed in a 10 L reaction vessel fitted with a cooling jacket, stainless steel stirrer, pH control and thermometer. The stirrer was started and 320 g 50 wt. % aq. NaOH, 290 g acrylic acid and 137.5 g HPA were charged into the reactor. Under nitrogen purging and further stirring the liquid was heated to 49° C. At this temperature 2.9 g Wako VA-044 dissolved in 50 g water were added. An exothermic reaction was observed and the cooling was activated. Next, the addition of 680 g acrylic acid, 318 g HPA and 400 g 50 wt. % NaOH was started. These components were dosed via peristaltic pumps at a rate of 700 g/h, 300 g/h resp. 450 g/h. The addition of NaOH was adjusted to keep the pH between 4.5-5.5. During the polymerization a maximum temperature of 82° C. was reached. The dosage of the monomers was finished after 68 min.

The final polymer solution had a viscosity of 55 000 mPas (20° C.) and a solid content of 25 wt. %. pH was measured as 5.7.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 600 mPas. Residual acrylic acid was determined by HPLC as 0.34 wt. % and residual HPA as 0 wt. %. The molecular weight (M_{w}) was measured by GPC as 851,000 Da. The insoluble content was determined as <1 wt. %.

### Inventive Example 16

Copolymer of sodium acrylate (79.5 mol %) and hydroxypropyl acrylate (20.5 mol %) made by the process according to the present invention.

4200 g water were placed in a 10 L reaction vessel fitted with a cooling jacket, stainless steel stirrer, pH control and thermometer. The stirrer was started and 320 g 50 wt. % aq. NaOH, 290 g acrylic acid and 137.5 g HPA were charged into the reactor. Under nitrogen purging and further stirring the liquid was heated to 49° C. At this temperature 2.9 g Wako VA-044 dissolved in 50 g water were added. An exothermic reaction was observed and the cooling was activated. Next, the addition of 680 g acrylic acid, 318 g HPA and 450 g 50 wt. % NaOH was started. These components were dosed via peristaltic pumps at a rate of 600 g/h, 300 g/h resp. 450 g/h. The addition of NaOH was adjusted to keep the pH between 4.5-6. During the polymerization a maximum temperature of 79° C. was reached. The dosage of the monomers was finished after 62 min.

The final polymer solution had a viscosity of 43 000 mPas (20° C.) and a solid content of 22.8 wt. %. pH was measured as 6.2.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 490 mPas. Residual acrylic acid was determined by HPLC as 0.36 wt. % and residual HPA as 0 wt. %. The molecular weight (M_{w}) was measured by GPC as 1,263,000 Da. The insoluble content was determined as <1 wt. %.

### Inventive Example 17

Copolymer of sodium acrylate (79.5 mol %) and hydroxypropyl acrylate (20.5 mol %) made by the process according to the present invention.

At the end of the reaction additional initiator was added, in order to decrease the amount of residual monomers.

4200 g water were placed in a 10 L reaction vessel fitted with a cooling jacket, stainless steel stirrer, pH control and thermometer. The stirrer was started and 320 g 50 wt. % aq. NaOH, 290 g acrylic acid and 137.5 g HPA were charged into the reactor. Under nitrogen purging and further stirring the liquid was heated to 49° C. At this temperature 2.9 g Wako VA-044 dissolved in 50 g water were added. An exothermic reaction was observed and the cooling was activated. Next, the addition of 680 g acrylic acid, 318 g HPA and 450 g 50 wt. % NaOH was started. These components were dosed via peristaltic pumps at a rate of 600 g/h, 300 g/h resp. 450 g/h. The addition of NaOH was adjusted to keep the pH between 4.5-6. During the polymerization a maximum temperature of 79° C. was reached. The dosage of the monomers was finished after 62 min. After 30 min further stirring 0.5 g Wako VA-044 dissolved in 50 g water were added to reduce the residual monomer content.

The final polymer solution had a viscosity of 52 000 mPas (20° C.) and a solid content of 22.8 wt. %. pH was measured as 6.2.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 690 mPas. Residual acrylic acid was determined by HPLC as 0.22 wt. % and residual HPA as 0 wt. %. The molecular weight (M_{w}) was measured by GPC as 1,295,000 Da. The insoluble content was determined as <1 wt. %.

### Inventive Example 18

Copolymer of sodium acrylate (79.5 mol %) and hydroxypropyl acrylate (20.5 mol %) made by the process according to the present invention.

4200 g water were placed in a 10 L reaction vessel fitted with a cooling jacket, stainless steel stirrer, pH control and thermometer. The stirrer was started and 320 g 50 wt. % aq. NaOH, 290 g acrylic acid and 137.5 g HPA were charged into the reactor. Under nitrogen purging and further stirring the liquid was heated to 49° C. At this temperature 3.3 g Wako VA-044 dissolved in 50 g water were added. An exothermic reaction was observed and the cooling was activated. Next, the addition of 680 g acrylic acid, 318 g HPA and 450 g 50 wt. % NaOH was started. These components were dosed via peristaltic pumps at a rate of 600 g/h, 300 g/h resp. 450 g/h. The addition of NaOH was adjusted to keep the pH between 4.5-6. During the polymerization a maximum temperature of 83° C. was reached. The dosage of the monomers was finished after 67 min.

The final polymer solution had a viscosity of 14 000 mPas (20° C.) and a solid content of 23.5 wt. %. pH was measured as 6.2.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 290 mPas. Residual acrylic acid was determined by HPLC as 0.37 wt. % and residual HPA as 0 wt. %. The molecular weight (M_{w}) was measured by GPC as 1,101,000 Da. The insoluble content was determined as <1 wt. %.

### Inventive Example 19

Copolymer of sodium acrylate (79.5 mol %) and hydroxypropyl acrylate (20.5 mol %) made by the process according to the present invention.

At the end of reaction additional initiator was added in order to decrease the amount of residual monomers.

4200 g water were placed in a 10 L reaction vessel fitted with a cooling jacket, stainless steel stirrer, pH control and thermometer. The stirrer was started and 320 g 50 wt. % aq. NaOH, 290 g acrylic acid and 137.5 g HPA were charged into the reactor. Under nitrogen purging and further stirring the liquid was heated to 49° C. At this temperature 3.3 g Wako VA-044 dissolved in 50 g water were added. An exothermic reaction was observed and the cooling was activated. Next, the addition of 680 g acrylic acid, 318 g HPA and 450 g 50 wt. % NaOH was started. These components were dosed via peristaltic pumps at a rate of 600 g/h, 300 g/h resp. 450 g/h. The addition of NaOH was adjusted to keep the pH between 4.5-6. During the polymerization a maximum temperature of 83° C. was reached. The dosage of the monomers was finished after 67 min. After 30 min further stirring 0.5 g Wako VA-044 dissolved in 50 g water were added to reduce the residual monomer content.

The final polymer solution had a viscosity of 18 000 mPas (20° C.) and a solid content of 23.5 wt. %. pH was measured as 6.2.

The solution was dried with a lab drum dryer (type Merto Drum L, producer Deutsche Vakuum Apparate, Holland Merten GmbH) at a temperature of 170° C. and rotation speed of 1 rpm. The viscosity of a 5 wt. % aqueous solution of the resulting powder was measured as 370 mPas. Residual acrylic acid was determined by HPLC as 0.19 wt. % and residual HPA as 0 wt. %. The molecular weight (M_{w}) was measured by GPC as 1,086,000 Da. The insoluble content was determined as <1 wt. %.

### Application Tests

### Dispersion Test

Shale inhibition is achieved by certain additives to drilling fluids which prevent clays or shale from taking-up water (i.e. from swelling) and by providing cuttings integrity.

The level of shale inhibition provided by different drilling fluid additives and formulations is routinely assessed by test such as cuttings dispersion. A good indication of the inhibitive properties of an additive can be obtained by a modification of the standard oilfield cuttings dispersion test based on API RP 13| Section 23: Shale-particle disintegration test by hot rolling. This test is used to screen the effectiveness of inhibitor additives to maintain the integrity of the cuttings and minimize the interaction of fluids with the shale sections during the drilling and completions operations.

### Test Principle:

A known weight of shale cuttings (size 2 to 5 mm, approx. 25 g) is added to a measured volume of the aqueous fluid to be tested (approximately 175 ml) in a container. The container is rotated (hot rolling for about 16 h at 93° C.) such that the cuttings are in constant state of agitation in the fluid; this encourages breakdown and dispersion of the cuttings if they become softened due to interaction with the test fluid. After hot rolling for 16 h the container is cooled to room temperature and the fluid containing the cuttings is poured over a 0.5 mm sieve, the retained shale pieces are recovered, and washed with 4 wt. % KCl aqueous solution and dried 3.5 h at 110° C. Afterwards, the sample is re-weighted to determine the percent of shale recovered. The remaining part became dispersed and passed through the sieve. The recovered weight is expressed as a percentage of the original weight added to the test fluid. The more inhibitive the test fluid, the lower the level of cuttings dispersion and hence the higher the amount of shale cuttings recovered.

### Detailed Procedure:

The basis of an aqueous drilling fluid typically is a suspension of finely divided bentonite in water. Therefore, as starting material for the drilling fluid to be tested, an aqueous suspension of bentonite (10 wt. %) is prepared.

### Preparation of a Suspension Comprising 10 wt. % of Bentonite:

1. 450 g of deionized water are added into a 11 plastic bottle,
2. the water is stirred with overhead mixer,
3. 50 g of untreated sodium montmorillonite clay (Cebogel® Premium NT) are added to the water and stirred at least for 1 h, and
4. after stirring with overhead mixer, the bottle is closed and shaken vigorously (to get rid of the lumps).

### Preparation of the Drilling Fluid:

1. 50 g of a bentonite suspension (10 wt. % Bentonite) are added into the cup of a Hamilton beach mixer,
2. 305 g of deionized water are added into the Hamilton beach mixer and stirred at “low” for 5 min,
3. 15 g of KCl are added into the Hamilton beach mixer and stirred for 5 min,
4. 2 g of the shale encapsulator are added and stirred for 20 min (if there are still lumps, stir for further 20-40 min). The amount of 2 g relates to the solid shale inhibitor; if the shale inhibitor is a solution or dispersion, the amount of 305 g water is reduced accordingly to ensure that the polymer contents is the same in all experiments (0.5 wt. %, relating to the total of all components of the drilling fluid),
5. the drilling fluid is split in 2 parts and each part is added in a 250 ml glass bottle,
6. 25 g of bentonite cuttings (size 2 to 5 mm) are added in each bottle, the bottle are closed and shaken quickly to coat all cuttings with the drilling fluid,
7. the mixture is left aging for 16 h at 93.3° C., and
8. the mud is cool down after aging in a water bath and then, the sieve test is carried out.

### Sieve Test

1. 500 μm sieves are weighed when they are dry,
2. the aged drilling fluid with cuttings is poured across the sieve and the cuttings are washed with a 4 wt. % KCl solution, until the washing solution is clear after running through the sieve with cuttings,
3. the sieve is dried with a paper towel and weighed with the wet cuttings,
4. the cuttings are dried in the sieve at 110° C. until a constant mass was measured (3.5 h is sufficient),
5. the shale recovery is calculated in %, and
6. an average shale recovery is calculated from 2 tests.

Table 1 shows the results of the dispersion tests carried out for samples of each of the examples above described

TABLE 1
Results of the samples' analysis

| | | | | | | | | | Initiator vs. | | |
|---|---|---|---|---|---|---|---|---|---|---|---|
| | | | | | | | | | monomers [%] | | |
| | | | | Addition of monomers | | | | | | | Peroxo- |
| | Acrylate | HPA | Tₛₜₐᵣₜ | mix- | sepa- | Initial | Time | Tₘₐₓ | Azo | Azo | disul- |
| sample | [mol %] | [mol %] | [° C.] | ture | rately | charge | [min] | [° C.] | V50 | V44 | phate |
| CE-1 | 79.5 | 20.5 | — | — | — | — | — | — | — | — | — |
| CE-2 | 79.5 | 20.5 | — | — | — | — | — | — | — | — | — |
| IE-1 | 79.5 | 20.5 | 55 | x | — | — | 35 | 63 | 0.14 | — | 0.53 |
| IE-2 | 79.5 | 20.5 | 57 | x | — | — | 60 | 62 | 0.14 | — | 0.53 |
| IE-3 | 79.5 | 20.5 | 53 | x | — | — | 90 | 65 | 0.17 | — | 0.71 |
| IE-4 | 85 | 15 | 55 | x | — | — | 90 | 65 | 0.14 | — | 0.58 |
| IE-5 | 75 | 25 | 55 | x | — | — | 90 | 65 | 0.12 | — | 0.51 |
| IE-6 | 79.5 | 20.5 | 54 | — | x | 30% | 70 | 70 | 0.15 | — | 0.63 |
| CE-3 | 79.5 | 20.5 | 58 | — | x | — | 80 | n.a. | 0.15 | — | 0.63 |
| IE-7 | 79.5 | 20.5 | 56 | — | x | 10% | 70 | 73 | 0.15 | — | 0.64 |
| IE-8 | 79.5 | 20.5 | 55 | — | x | 30% | 60 | 69 | 0.15 | — | 0.63 |
| IE-9 | 79.5 | 20.5 | 57 | — | x | 30% | 60 | 72.5 | 0.53 | — | |
| IE-10 | 79.5 | 20.5 | 49 | — | x | 30% | 64 | 77 | — | 0.21 | — |
| IE-11 | 79.5 | 20.5 | 49 | — | x | 30% | 70 | 62.5 | — | 0.42 | — |
| IE-12 | 79.5 | 20.5 | 49 | — | x | 30% | 70 | 66 | — | 0.42 | — |
| IE-13 | 79.5 | 20.5 | 49 | — | x | 30% | 70 | 66 | — | 0.42 | — |
| IE-14 | 79.5 | 20.5 | 49 | — | x | 30% | 64 | 82 | — | 0.25 | — |
| IE-15 | 79.5 | 20.5 | 49 | — | x | 30% | 68 | 82 | — | 0.2 | — |
| IE-16 | 79.5 | 20.5 | 49 | — | x | 30% | 62 | 79 | — | 0.2 | — |
| IE-17 | 79.5 | 20.5 | 49 | — | x | 30% | 62 | 79 | — | 0.2 + | — |
| | | | | | | | | | | 0.04 | |
| IE-18 | 79.5 | 20.5 | 49 | — | x | 30% | 67 | 83 | — | 0.23 | — |
| IE-19 | 79.5 | 20.5 | 49 | — | x | 30% | 67 | 83 | — | 0.23 + | — |
| | | | | | | | | | | 0.04 | |

| | | | Viscosity | | Average | | |
|---|---|---|---|---|---|---|---|
| | | Final | 5% aq. | | dry | Shale | |
| | Final | conc. | Solution | M_{w} | cuttings | recovery | |
| sample | pH | [wt. %] | [mPas] | [g/mol] | [g] | [%] | Remarks |
| CE-1 | — | — | 140 | 823,000 | 13.32 | 53.3 | Bead |
| | | | | | | | polymer- |
| | | | | | | | ization |
| CE-2 | — | 13.5 | 4050 | 1,900,000 | 11.26 | 45 | Solution |
| | | | | | | | polymer- |
| | | | | | | | ization |
| IE-1 | 5.7 | 18.4 | 820 | 1,191,000 | 12.92 | 51.7 | |
| IE-2 | 5.7 | 18.2 | 230 | 834,000 | 12.41 | 49.6 | |
| IE-3 | 6.1 | 22.8 | 300 | 701,000 | 13.0 | 52 | |
| IE-4 | 4.9 | 23.0 | 600 | 1,116,000 | 15.00 | 60 | |
| IE-5 | 4.9 | 24.1 | 600 | 1,097,000 | 13.39 | 53.6 | |
| IE-6 | 4.5 | 22.0 | 300 | 944,000 | 14.27 | 57.1 | |
| CE-3 | 5.5 | 24.4 | 320 | 1,200,000 | 15.50 | 62.0 | Sample |
| | | | | | | | not dried |
| IE-7 | 5.2 | 25.0 | 90 | 663,000 | 12.60 | 50.4 | |
| IE-8 | 4.6 | 25.0 | 350 | 1,141,000 | 12.74 | 50.9 | |
| IE-9 | 4.2 | 24.5 | 180 | 1,000,000 | 13.0 | 52 | Only azo |
| | | | | | | | initiator |
| IE-10 | n.a. | 23.3 | 990 | 1,218,000 | 14.69 | 58.8 | |
| IE-11 | 4.9 | 22.6 | 1,500 | 1,176,000 | 15.14 | 60.6 | |
| IE-12 | 5.3 | 23.1 | 400 | 1,049,000 | 14.57 | 58.3 | |
| IE-13 | 5.7 | 23 | 300 | 950,000 | 12.04 | 48.2 | |
| IE-14 | 6.1 | 25 | 260 | 878,000 | 13.25 | 53 | |
| IE-15 | 5.7 | 25 | 600 | 851,000 | 15.27 | 61.1 | |
| IE-16 | 6.2 | 22.8 | 490 | 1,263,000 | 13.68 | 54.7 | |
| IE-17 | 6.2 | 22.8 | 690 | 1,295,000 | 14.66 | 58.6 | Additional |
| | | | | | | | initiator |
| | | | | | | | added after |
| | | | | | | | monomer |
| | | | | | | | dosage |
| IE-18 | 6.2 | 23.5 | 290 | 1,101,000 | 14.23 | 56.9 | |
| IE-19 | 6.2 | | 370 | 1,086,000 | 15.86 | 63.4 | Additional |
| | | | | | | | initiator |
| | | | | | | | added after |
| | | | | | | | monomer |
| | | | | | | | dosage |

1.-18. (canceled)

19. A method for preparing a water-soluble polymer in powder form by radically polymerizing at least two water-soluble, monoethylenically unsaturated monomers (A) and (B), the method comprising:
i) adding an aqueous base fluid into a vessel,
ii) adding at least one radical initiator into the vessel and dissolving the radical initiator(s) in the aqueous base fluid,
iii) continuously dosing the monomers into the vessel, and
iv) removing the obtained water-soluble polymer from the vessel and drying it,
wherein the maximum temperature of the vessel is equal or less than 100° C. at any point during the method, and wherein
monomer (A) is of the formula H₂C═C(R¹)—CO—X—R², wherein R¹ is H or CH₃, X is O or NR³, wherein R³ is H or CH₃, and R² is a hydrocarbon group comprising at least one OH pendant group or a group of the formula —(CH₂CH(R⁴)—O)ₙR⁵, wherein R⁴ and R⁵ are, independently, H or CH₃, and n is chosen from 1 to 20, and wherein the amount of monomer (A) is 0.1 to 30 mol %, relating to the total of all monomers, and
monomer (B) is a monomer different from (A), having the general formula H₂C═C(R¹)—R⁶, wherein R¹ has the meaning as defined above, and R⁶ is a hydrophilic group, and wherein the amount of monomer (B) is 70 to 99.9 mol %, relating to the total of all monomers.

20. The method according to claim 19, wherein in step iv) the polymer is dried using a drum dryer.

21. The method according to claim 19, wherein an additional amount of at least one radical initiator is added into the vessel after step iii).

22. The method according to claim 19, wherein in step iii) the monomers are dosed continuously into the vessel over the course of 15-120 min.

23. The method according to claim 19, wherein the monomers in step iii) are added as a monomer mixture.

24. The method according to claim 19, wherein the monomers in step iii) are added separately.

25. The method according to claim 19, wherein after the completion of the monomers dosing, the reaction mixture obtained in step iii) is further stirred for 30 min to 3 h and at a temperature between 45 to 85° C.

26. The method according to claim 19, wherein up to 30 wt. % of the monomers used in the method, relating to the total amount of monomers added into the vessel during the method, is added into the vessel between the steps i) and ii).

27. The method according to claim 19, wherein the maximum temperature of the vessel is equal or less than 90° C. at any point during the method.

28. The method according to claim 19, wherein the radical initiator(s) has a 10 h t1/2 temperature in water of 20 to 70° C.

29. The method according to claim 19, wherein the water-soluble polymer comprises 5 to 25 mol % of at least one monomer (A), relating to the total of all monomers.

30. The method according to claim 19, wherein at least one monomer (B) is (meth)acrylic acid or a salt thereof.

31. The method according to claim 30, wherein the water-soluble polymer comprises 75-85 mol % of (meth)acrylic acid or a salt thereof and 15-25 mol % of monomer (A).

32. The method according to claim 19, wherein at least one monomer (A) is selected from hydroxyalkyl (meth)acrylates, hydroxyalkyl (meth)acrylamide and amino alcohol (meth)acrylates, wherein the term “alkyl” is a linear alkyl group comprising 1 to 12 carbon atoms.

33. The method according to claim 32, wherein at least one monomer (A) is hydroxypropyl (meth)acrylate.

34. The method according to claim 19, wherein the final polymer concentration in the reaction vessel before step iv) is in the range of 18 to 35 wt. %.

35. A method for preparing a water-soluble polymer for oil drilling operations, wherein the water-soluble polymer is in powder form, by radically polymerizing at least two water-soluble, monoethylenically unsaturated monomers (A) and (B), the method comprising:
i) adding an aqueous base fluid into a vessel,
ii) adding at least one radical initiator into the vessel and dissolving the radical initiator(s) in the aqueous base fluid,
iii) continuously dosing the monomers into the vessel, and
iv) removing the obtained water-soluble polymer from the vessel and drying it,
wherein the maximum temperature of the vessel is equal or less than 100° C. at any point during the method, and wherein
monomer (A) is of the formula H₂C═C(R¹)—CO—X—R², wherein R¹ is H or CH₃, X is O or NR³, wherein R³ is H or CH₃, and R² is a hydrocarbon group comprising at least one OH pendant group or a group of the formula —(CH₂CH(R⁴)—O)ₙR⁵, wherein R⁴ and R⁵ are, independently, H or CH₃, and n is chosen from 1 to 20, and wherein the amount of monomer (A) is 0.1 to 30 mol %, relating to the total of all monomers, and
monomer (B) is a monomer different from (A), having the general formula H₂C═C(R¹)—R⁶, wherein R¹ has the meaning as defined above, and R⁶ is a hydrophilic group, and wherein the amount of monomer (B) is 70 to 99.9 mol %, relating to the total of all monomers.

36. The method according to claim 35, wherein the water-soluble polymer is used as shale encapsulator or shale inhibitor.
